(19) United States
(12) Patent Application Publication
(10) Pub. No.: US 2024/0084184 A1
(43) Pub. Date: Mar. 14, 2024

(54) THERMOCHEMICAL ENERGY STORAGE DEVICE

(71) Applicant: TECHNISCHE UNIVERSITAT WIEN, Wien (AT)

(72) Inventors: Franz WINTER, Wien (AT); Julia TOMASICH, Wien (AT); Harald BURGMAYR, Wien (AT); Clemens HUBER-STEINKELLNER, Wien (AT)

(21) Appl. No.: 18/274,434

(22) PCT Filed: Jan. 26, 2022
(86) PCT No.: PCT/AT2022/060024

§ 371 Date: Jul. 26, 2023

(30) Foreign Application Priority Data
Jan. 26, 2021 (AT) 50039/2021

(51) Int. Cl. C09K 5/16; C01B 35/10; F28D 20/00

(52) U.S. Cl. CPC C09K 5/16; C01B 35/1054; F28D 20/003

(57) ABSTRACT

Process for the reversible thermochemical storage of energy and release of energy, wherein, for the storage of energy, orthoboric acid is converted into boric oxide, metaboric acid or boric oxide and metaboric acid by loss of water, wherein, for the release of energy, boric oxide or metaboric acid or boric oxide and metaboric acid are converted into orthoboric acid by reaction with water, wherein the reactions take place in a suspension medium, wherein for the reversible storage of energy, orthoboric acid is present suspended in the suspension medium, and wherein the suspension medium containing orthoboric acid is brought to a temperature at which water loss occurs via an energy source, wherein for the reversible thermochemical release of energy boric oxide and/or metaboric acid are present suspended in a suspension medium, wherein water is added to the suspension medium containing boric oxide or metaboric acid or boric oxide and metaboric acid so that the reaction proceeds to orthoboric acid, wherein the heat generated in this process is dissipated to a heat consumer.

The present invention relates to a process for the reversible thermochemical storage of energy and release of energy. Further, the invention relates to a system comprising a thermochemical energy storage system.

### BACKGROUND TO THE INVENTION

In thermochemical energy storage systems, heat is stored by endothermic reactions and released by exothermic reactions. Such thermochemical energy stores use reversible reactions according to the scheme A+B→C (+D) for energy storage and the reverse reaction C+(D)→A+B for energy release.

Compared with heat storage systems using water as the energy carrier, thermochemical energy storage systems have the advantages of higher energy storage density and the possibility of long-term storage; compared with latent heat storage systems, the higher energy storage density is a significant advantage. Major criteria that currently limit the practical use of thermochemical energy storage systems are, on the one hand, the high cost of chemical substances that enable meaningful energy storage and/or, on the other hand, the maximum number of storage cycles (i.e., the number of reversible conversions of the chemical substances in the reaction system). As the number of storage cycles increases, a reduction in the quality of the substances is observed, caused, for example, by abrasion, corrosion, sintering or aging.

The low number of storage cycles is the decisive limiting factor here. Therefore, thermochemical energy storage is currently still limited to laboratory scale and prototypes.

AT 518 448 B1 describes a thermochemical energy accumulator which uses the reversible reaction equilibrium between boric acid and anhydride of boric acid (borontrioxide) according to the reaction scheme

2H₃BO₃⇄B₂O₃+3H₂O

as a system for storing energy (boric acid/boron(III) oxide system).

While the cost of the substances required in the boric acid/borontrioxide reaction system is relatively low, the maximum number of storage cycles is low because agglomeration of the substances can be observed. Agglomeration negatively affects the reaction kinetics, so that the maximum number of storage cycles and the storage capacity are reduced. AT 518 448 B1 attempts to remedy this problem by using a fluidized bed reactor in the energy storage system. In the fluidized bed reactor, the substances are in a floating bed, which on the one hand reduces agglomeration and on the other hand accelerates the kinetics of the reaction. Agglomeration is not completely prevented in AT 518 448 B1. Although the number of cycles in the boric acid/boron(III) oxide reaction system can be increased with the fluidized bed reactor, agglomerates can also be observed after a few cycles in the fluidized bed reactor. The number of cycles gained does not outweigh the higher costs for the fluidized bed reactor itself and the complex control of the reaction process in the fluidized bed reactor.

### BRIEF DESCRIPTION OF THE INVENTION

The object of the present invention is to provide a thermochemical energy storage device and a process, based on the reversible reaction system boric acid/boron(III) oxide, which allows a higher number of storage cycles at low operating costs and easy handling.

This task is solved by a
process for the reversible thermochemical storage of energy,
comprising a reaction system in which orthoboric acid (H₃BO₃) is converted into boric oxide (B₂O₃), metaboric acid (HBO₂, H₂B₄O₇) or boric oxide (B₂O₃), and metaboric acid (HBO₂, H₂B₄O₇) by loss of water,
   characterized in that the orthoboric acid (H₃BO₃) is present suspended in a suspension medium, wherein the suspension medium containing orthoboric acid (H₃BO₃) is brought to a temperature at which water loss occurs via an energy source.

Orthoboric acid is present as a powder, which is suspended in a suspension medium. A suspension medium is a liquid in which boric acid is not soluble and in which boric acid can be suspended.

The inventors have found that the agglomeration tendency of the reversible reactions of orthoboric acid to metaboric acid or boric oxide (boric acid/boric oxide system), according to the reactions

2H₃BO₃⇄B₂O₃+3H₂O

or

2H₃BO₃⇄2HBO₂+2H₂O and then

2HBO₂⇄2B₂O₃+H₂O

or

2H₃BO₃⇄2HBO₂+2H₂O and

2HBO₂⇄½H₂B₄O₇+½H₂O and

½H₂B₄O₇⇄B₂O₃+½H₂O

or the reverse reactions is greatly reduced if the reactions are carried out in a suspension medium, resulting in a higher maximum number of storage cycles. Thus, the storage capacity also remains substantially constant throughout the number of storage cycles. In this process and in the processes described below, the dehydration of an acid (H₃BO₃) to the corresponding anhydride (HBO₂, H₂B₄O₇ or B₂O₃) or the hydration of an anhydride (HBO₂, H₂B₄O₇ or B₂O₃) to the corresponding acid (H₃BO₃) is used to store or release energy. In handling, it has been shown that acid/anhydride systems are much more prone to agglomeration than, for example, systems based on the intercalation of water of crystallization, e.g. in salts, or the sorption of water on the surface. All the more surprising were the findings in the boric acid/boron oxide system in suspension, according to which agglomeration is considerably reduced by a suspension medium, so that the maximum number of storage cycles can be increased by a factor of 10 to 100.

The details described below, such as material quantities, temperatures, pressure, process conditions or details of the equipment, can also be applied to reversible thermochemical energy release, which is described below.

Suitable suspension media include refined rapeseed oil, mineral oil-based thermal oil, silicone-based thermal oil, bio-oil and the like.

Preferably, the mass ratio of orthoboric acid to suspension medium used for thermochemical energy storage at the start of the reaction is 1 (H₃BO₃) to 0.6 to 1.2 (suspension medium), preferably 1 (H₃BO₃) to 0.9 to 1.0 (suspension medium), preferably about 1:0.83. If the amount of suspension medium in relation to H₃BO₃ becomes too large, the storage capacity decreases; if, on the other hand, the amount of suspension medium in relation to H₃BO₃ becomes too small, isolated agglomerates may occur. In the context of the patent application, the mass ratio is understood as the ratio of mass to mass.

The energy density, corresponding to the storage capacity of the energy storage medium, is 2.2 GJ/m³ for boric acid in relation to boric oxide. In suspension, the energy density decreases to 1.32 GJ/m³ in a thermal oil as suspension medium at a 1:0.83 mass ratio.

Preferably, the suspension medium with the orthoboric acid suspended therein is agitated, especially preferably stirred, during the reaction. This results in better heat distribution in the suspension and improves the reaction kinetics.

In one embodiment, the water formed is removed from the suspension during the course of the reaction. This shifts the reaction equilibrium to the side of the metaboric acid and the boron oxide and the back reaction to orthoboric acid is prevented.

The temperature range for loading (energy storage) is preferably 110° C. to 200° C., particularly preferably between 135-165° C., and loading can be carried out at, for example, about 1.0135 bar. In order to shift the reaction equilibrium towards the metaboric acid side or boron oxide side, it has been found advantageous if the pressure is below 1.0135 bar. Preferably, the pressure is below 200 mbar, preferably below 100 mbar, for example at least 1 mbar.

Typical charging but also discharging times are about 0.5-1 hours. This results in theoretical power densities of 0.367 MW/m 3 (for a discharge time of 60 minutes) and 0.733 MW/m 3 (for a discharge time of 30 minutes) for a suspension in a suspension medium at a 1:0.83 mass ratio.

Accordingly, the invention also relates to a
process for the reversible thermochemical release of energy,
comprising a reaction system in which boric oxide (B₂O₃) or metaboric acid (HBO₂, H₂B₄O₇) or boric oxide (B₂O₃) and metaboric acid (HBO₂, H₂B₄O₇) are converted into orthoboric acid (H₃BO₃) by reaction with water,
   characterized in that boric oxide (B₂O₃) or metaboric acid or boric oxide (B₂O₃) and metaboric acid (HBO₂, H₂B₄O₇) are present suspended in a suspension medium, wherein water, preferably liquid and/or gaseous water, is added to the suspension medium, so that the reaction to orthoboric acid (H₃BO₃) proceeds.

The invention also relates to a for the reversible thermochemical storage of energy and release of energy,
wherein, for the storage of energy, orthoboric acid (H₃BO₃) is converted into boric oxide (B₂O₃), metaboric acid (HBO₂, H₂B₄O₇) or boric oxide (B₂O₃), and metaboric acid (HBO₂, H₂B₄O₇) by loss of water,
wherein, for the release of energy, boric oxide (B₂O₃) or metaboric acid (HBO₂, H₂B₄O₇) or boric oxide (B₂O₃) and metaboric acid (HBO₂, H₂B₄O₇) are converted into orthoboric acid (H₃BO₃) by reaction with water,
   characterized in that the reactions take place in a suspension medium,
wherein for the reversible storage of energy, orthoboric acid (H₃BO₃) is present suspended in the suspension medium, and wherein the suspension is brought to a temperature at which loss of water occurs via an energy source,
wherein for the reversible thermochemical release of energy boric oxide (B₂O₃) or metaboric acid (HBO₂, H₂B₄O₇) or boric oxide (B₂O₃) and metaboric acid (HBO₂, H₂B₄O₇) are present suspended in the suspension medium, wherein water is added to the suspension, so that the reaction proceeds to orthoboric acid (H₃BO₃), wherein the heat generated in this process is dissipated to a heat consumer.

The processes according to the invention are based on the reversible reactions of orthoboric acid to metaboric acid to boric oxide and vice versa. For the storage of energy, starting from orthoboric acid either metaboric acid (which is a multistep process according to Huber et al. “The multistep decomposition of boric acid,” Energy Sci Eng. 2020; 00:1-17) and/or boric oxide is produced by loss of water. Release of energy release utilizes the reverse reaction of boric oxide and/or metaboric acid with water to form orthoboric acid:

### Charging Process

2H₃BO₃⇄B₂O₃+3H₂O

2H₃BO₃⇄2HBO₂+2H₂O

2HBO₂⇄2B₂O₃+H₂O

2H₃BO₃⇄2HBO₂+2H₂O

2HBO₂⇄½H₂B₄O₇+½H₂O

½H₂B₄O₇⇄B₂O₃+½H₂O

### Decharging Process:

2H₃BO₃⇄B₂O₃+3H₂O

2H₃BO₃⇄2HBO₂+2H₂O

2HBO₂⇄2B₂O₃+H₂O

2H₃BO₃⇄2HBO₂+2H₂O

2HBO₂⇄½H₂B₄O₇+½H₂O

½H₂B₄O₇⇄B₂O₃+½H₂O

The conversion of H₃BO₃ into B₂O₃ and vice versa proceeds in several steps via metaboric acid. Metaboric acid is characterized here via the molecular formulae HBO₂ and H₂B₄O₇, but may also have other molecular formulae between H₃BO₃ and B₂O₃. Thus, there are other structures of metaboric acids that are also covered in the sense of the invention. The starting point for the processes is either orthoboric acid or boron oxide. For energy storage, however, there may then also be the formation of metaboric acid, which is no longer or no longer completely converted into boric oxide. It has also been found in the context of the invention that the reaction equilibrium orthoboric acid−water⇄metaboric acid+water, without boric oxide being generated, is even less prone to agglomeration.

Preferably, the mass ratio of boron oxide to suspension medium used for thermochemical energy release at the start of the reaction is 1 (B₂O₃) to 0.34 to 0.68 (suspension medium), preferably 1 (B₂O₃) to 0.51 to 0.56 (suspension medium), preferably about 1:0.47, with the proviso that between 0.70 to 0.85, preferably 0.75 to 0.80 g of water is added per 1 g of B₂O₃.

The amount of water added should be approximately stoichiometric (0.776 g H₂O per 1 g B₂O₃) to allow virtually complete conversion of B₂O₃ to H₃BO₃. Significantly larger amounts of water would lead to a solution, which is undesirable; too small amounts of water will lead to an incomplete reaction and thus to an incomplete utilization of the storage capacity.

The discharge time or energy release time can be about 0.5-1 hours to allow good energy dissipation. The water supply should also be regulated accordingly.

Discharge (energy release) can take place at approx. 1.0135 bar, for example. In order to achieve higher temperatures, it has proven advantageous if the pressure is above 1.0135 bar. Preferably, the pressure is at least 5 bar, particularly preferably at least 8 bar, for example up to 10 bar.

Additional additives, emulsifiers and/or foam inhibitors can be added to the suspension medium. Examples of such additives include quartz sand, non-ionic surfactants (e.g. alcoholic ethoxylates, alcoholic polyglycol ethers, fatty acid alcohols).

In the process according to the invention, the use of a suspension medium reduces the energy storage density. However, this disadvantage is more than offset due to the agglomeration prevented by the suspension medium and the maximum number of storage cycles gained as a result. In addition, process control is simpler and the storage and release of energy can easily take place at separate locations. For example, at the charging unit, suspension with B₂O₃ is removed after the charging process and exchanged for suspension with H₃BO₃. At the unloading unit, suspension containing B₂O₃ is used and, after unloading, the suspension now containing lower-energy H₃BO₃ is removed. Another advantage of the suspension medium is the improved heat transfer to the orthoboric acid.

Furthermore, the task is solved by a system for the thermochemical storage of energy and release of energy, in particular for carrying out one of the processes as mentioned above, with at least one suspension reactor, wherein an energy source is associated with the suspension reactor, wherein an agitation device is provided in the suspension reactor, wherein an outlet for water vapor from the suspension reactor and a water reservoir connected to the outlet is present, wherein a feed line is provided into the suspension reactor which is connected to the water reservoir, wherein a heat exchanger is provided at the suspension reactor, wherein the heat exchanger is connectable to a consumer

The agitation device can be, for example, a stirrer.

The system can further comprise a control device which is designed in such a way that the amount of energy delivered to the heat exchanger at the suspension reactor can be controlled.

In addition, a gas supply line may be provided for the suspension reactor to discharge water generated in the reactor.

Since the water produced is gaseous, a heat exchanger can be assigned to the gas supply line in order to heat supplied gas—preferably nitrogen—or to reduce the relative humidity.

A heat exchanger may be associated with the outlet, with which the gaseous water is condensed.

Furthermore, a device for controlling the flow rate can be assigned to the supply line. This makes it possible to control the amount of heat delivered.

With a control device designed in such a way that the amount of energy delivered to the heat exchanger at the suspension reactor can be controlled via the flow rate control device, the amount of heat delivered can also be controlled.

In one embodiment, two suspension reactors are provided, which are connected via at least one bypass line, whereby means are provided for transporting the contents of one suspension reactor into the other suspension reactor. This would allow energy to be stored and consumed in parallel if both processes are desired in parallel at certain times.

Furthermore, an energy source and a consumer can be provided.

### DETAILED DESCRIPTION OF THE INVENTION

The invention is explained in more detail with the aid of the figures and figure descriptions.

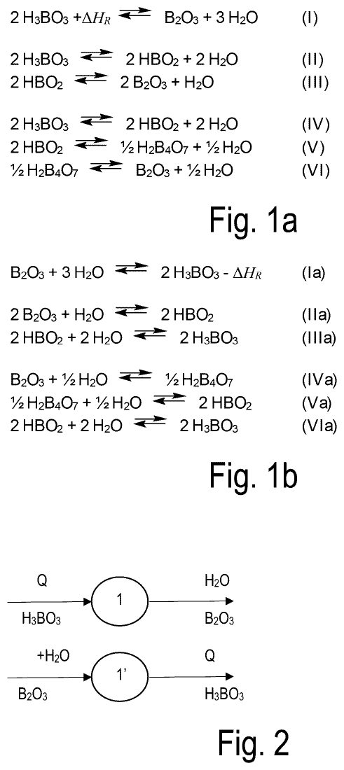

FIG. 1 schematically shows the reversible reaction equilibrium of the orthoboric acid/metaboric acid/boric oxide system for the charging process (FIG. 1a) and the discharging process (FIG. 1b) of a reactor and for the process according to the invention, respectively.

FIG. 2 schematically shows a system of one embodiment of a thermochemical energy storage system according to the invention or the process according to the invention.

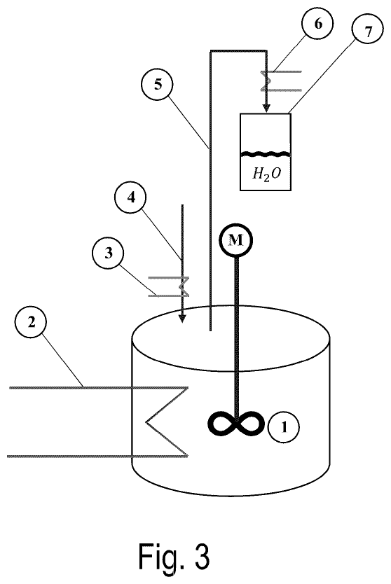

FIG. 3 schematically shows a system for carrying out a process for reversible thermochemical energy storage.

FIG. 3 schematically shows a system for carrying out a process for reversible thermochemical energy storage.

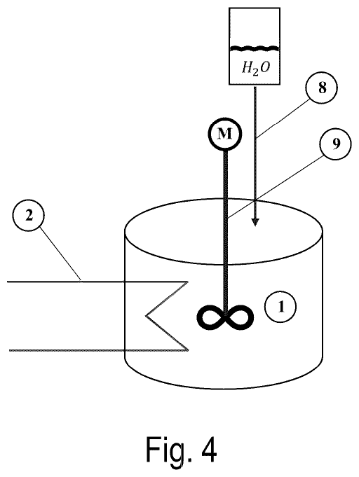

FIG. 4 schematically shows a system for carrying out a process for reversible thermochemical energy release.

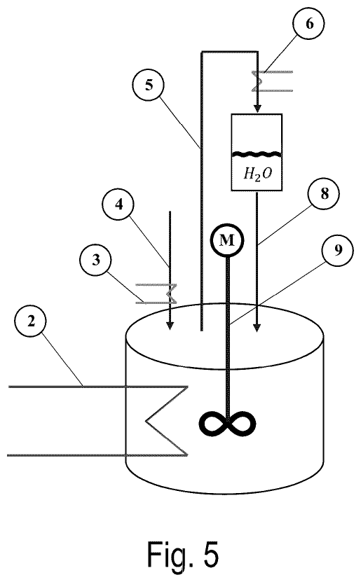

FIG. 5 schematically shows a system for carrying out a process for reversible thermochemical energy storage and release.

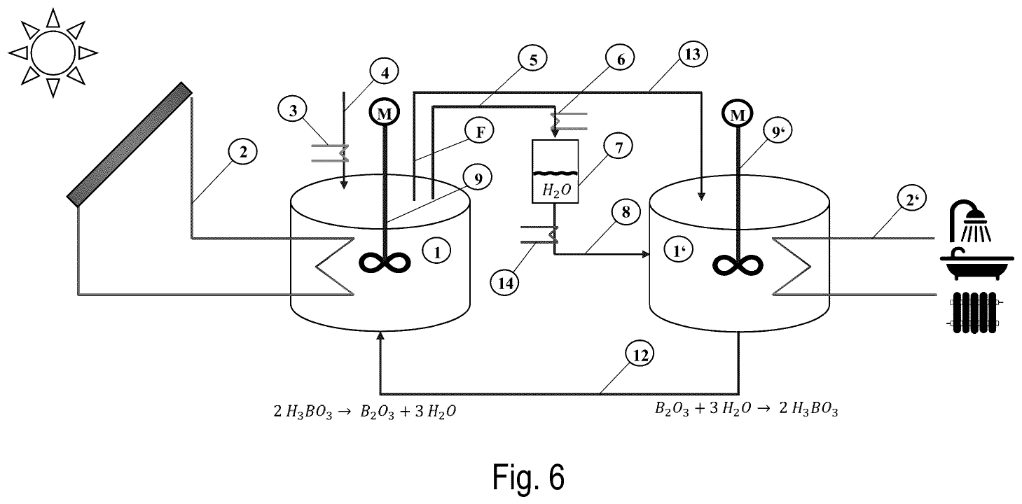

FIG. 6 schematically shows a system for carrying out a process for reversible thermochemical energy storage and release.

FIG. 1a shows the charging process and FIG. 1b the discharging process for a thermochemical reactor based on an orthoboric acid/metaboric acid/boron oxide system. The reactor contains powdered orthoboric acid suspended in a suspension medium (e.g. thermal oil). To charge the thermochemical energy store, the reaction enthalpy (ΔH_{R}) is supplied to the suspended orthoboric acid in the form of heat, so that reaction (I)) 2H₃BO₃→B₂O₃+3H₂O takes place. This reaction can also proceed in multiple steps via metaboric acid according to reactions (II) and (III) or (IV), (V) and (VI). The formation of boron oxide from orthoboric acid can be reduced or prevented by shorter reaction times and/or slightly lower temperatures (e.g., up to 150° C.). The reverse reaction (Ia) B₂O₃+3H₂O→2H₃BO₃ is used for discharge, releasing the reaction enthalpy. Again, the reaction process can be multistep according to reactions (Ha) and (IIIa) or (IVa), (Va) and (VIa). During the charging process, the water produced is removed.

This can be done, for example, by pumping, by applying a vacuum, via nitrogen gassing or the like. In order for these schematically illustrated reactions to take place in the processes according to the invention, they can take place in thermochemical reactors, as shown in the following figures.

FIG. 2 shows a schematic diagram of a thermochemical energy storage system according to the invention. A reactor 1 is provided in which there is a suspension of orthoboric acid in a suspension medium such as thermal oil, to which heat Q is supplied via an energy source not shown when the energy store is charged. Water, metaboric acid (not shown) and B₂O₃ are formed in the suspension. During the reaction, it is envisaged that the suspension is agitated, for example by stirring. The water is discharged from reactor 1 and can be stored if necessary. The suspension medium with metaboric acid and/or B₂O₃ remains in reactor 1. In the embodiment shown, the suspension medium with the boron oxide (and/or metaboric acid) in reactor 1′ may be contacted with water for heat release. The reactor 1′ may be a stand-alone reactor 1′ or the same reactor 1 as for energy storage. Water is added to reactor 1′ so that the reverse reaction B₂O₃+3H₂O→2H₃BO₃ occurs. Heat is released in the process, which is used for a consumer.

The reaction in reactor 1′ is preferably carried out in such a way that a stoichiometric amount of water is added, i.e., 3 moles of H₂O are added to 1 mole of B₂O₃. In addition, a metering device may be provided to meter the water flow and thus time the water supply so that the heat release is continuous. The water supplied to reactor 1′ may be the stored water released in reactor 1. If the stored water is used, a closed system can be used in which no feed is required and a stoichiometrically correct ratio between B₂O₃ and H₂O is automatically present. During the reaction in reactor 1′, it is also envisaged that the suspension is agitated, for example by stirring.

Reactor 1 can be operated with suspended orthoboric acid where large amounts of heat are generated, e.g. in industrial plants or at solar collectors. After reactor 1 is loaded with B₂O₃, the mixture of suspension medium and boron oxide can be removed and transported to a location where the energy in reactor 1′ is to be released again (e.g. in a single building heating system or a district heating system).

FIG. 3 shows a plant with a reactor 1—a suspension reactor—(filled with a suspension of thermal oil and orthoboric acid) for thermochemical energy storage. Energy in the form of heat for the reaction in reactor 1 is provided via an external energy source through line 2. The heat can come from a heating device or, for example, a solar collector or the like and be transferred to the reactor 1 via a heat exchanger. Furthermore, an agitating device 9 is provided with motor drive M to agitate the suspension. While the reaction is taking place, the resulting water vapor is drawn off from the suspension reactor 1 via the outlet (fume hood) 5, cooled via the heat exchanger 6 and stored in a reservoir 7. Furthermore, an external gas supply 4 with a dry gas such as nitrogen is provided to accelerate the water removal, whereby the gas of the external gas supply 4 can be preheated with a heating device 3.

FIG. 4 shows a system with a reactor 1 (suspension reactor) filled with a suspension of thermal oil and boron oxide for thermochemical energy release. Analogous to FIG. 3, an agitating device 9 is provided with motor drive M to agitate the suspension. In order for the reaction to proceed, water is fed into reactor 1 from a water reservoir 7 via feed line 8. The heat generated is dissipated via a conduit 2 to a heat exchanger and conducted to a consumer.

FIG. 5 shows a system for thermochemical energy storage and release, with a single reactor 1—a suspension reactor—(initially filled with a suspension of thermal oil and orthoboric acid). The system of FIG. 5 has essentially the two systems of FIGS. 3 and 4 and is used for energy storage and release. In the operating state of energy storage, energy for the reaction in reactor 1 is first provided via an external energy source through line 2. The suspension is stirred via an agitating device 9 with motor drive M. The resulting water vapor is drawn off from the suspension reactor 1 via the outlet 5, cooled via the heat exchanger 6 and stored in a reservoir 7. External gassing 4 with nitrogen is provided to accelerate the removal of water, and the nitrogen can be preheated by a heating device 3. When the reaction to B₂O₃ is complete, the system is charged. To release energy, the mode of operation is changed so that the reaction B₂O₃+H₂O proceeds. For this purpose, water is fed into the reactor from the water reservoir 7 via the feed line 8. The heat generated by the reaction is dissipated via a conduit 2 to a heat exchanger and conducted to a consumer.

The system according to FIG. 6 shows a design variant for thermochemical energy storage and release, with two reactors 1, 1′ (suspension reactors). One reactor 1 is initially filled with a suspension of thermo-oil and orthoboric acid and is used for energy storage. In the operating state of energy storage, energy for the reaction in reactor 1 is initially provided via an external energy source through line 2. In the embodiment example shown, the external energy source is a solar collector. Here, too, an agitating device 9 with motor drive M is provided to agitate the suspension. Water vapor produced is extracted from the suspension reactor 1 via the outlet 5, cooled via the heat exchanger 6 and stored in a reservoir 7. An external gassing 4 with nitrogen accelerates the water withdrawal and the heating device 3 can additionally heat the gas. When the reaction to B₂O₃ is complete, the system is charged. The suspension of B₂O₃ can be transferred to the second reactor 1′ via the bypass line 13. To release energy and to allow the reaction B₂O₃+H₂O to proceed, the mode of operation is changed. For this purpose, water is fed from the water reservoir 7 into the reactor 1′ via the feed line 8. A device for preheating and/or evaporating 14 the water is provided in the feed line. The heat generated by the reaction is conducted via a line 2′ to a heat exchanger and fed to a consumer. Conceivable consumers are radiators, hot water consumers, etc. After the reaction to H₃BO₃ has proceeded, the suspension can be returned to the first reactor 1′ via the bypass line 12. Then the charging process starts again.

1. A process for the reversible thermochemical storage of energy and release of energy,
wherein, for the storage of energy, orthoboric acid (H₃BO₃) is converted into boric oxide (B₂O₃), metaboric acid (HBO₂, H₂B₄O₇) or boric oxide (B₂O₃), and metaboric acid (HBO₂, H₂B₄O₇) by loss of water,
wherein, for the release of energy, boric oxide (B₂O₃) or metaboric acid (HBO₂, H₂B₄O₇) or boric oxide (B₂O₃) and metaboric acid (HBO₂, H₂B₄O₇) are converted into orthoboric acid (H₃BO₃) by reaction with water,
characterized in that the reactions take place in a suspension medium,
wherein for the reversible storage of energy, orthoboric acid (H₃BO₃) is present suspended in the suspension medium, and wherein the suspension medium containing orthoboric acid (H₃BO₃) is brought to a temperature at which water loss occurs via an energy source,
wherein for the reversible thermochemical release of energy boric oxide (B₂O₃) and/or metaboric acid (HBO₂, H₂B₄O₇) are present suspended in a suspension medium, wherein water is added to the suspension medium containing boric oxide (B₂O₃) or metaboric acid (HBO₂, H₂B₄O₇) or boric oxide (B₂O₃) and metaboric acid (HBO₂, H₂B₄O₇) so that the reaction proceeds to orthoboric acid (H₃BO₃), wherein the heat generated in this process is dissipated to a heat consumer.

2. A process for the reversible thermochemical storage of energy,
comprising a reaction system in which orthoboric acid (H₃BO₃) is converted into boric oxide (B₂O₃), metaboric acid (HBO₂, H₂B₄O₇) or boric oxide (B₂O₃), and metaboric acid (HBO₂, H₂B₄O₇) by loss of water,
characterized in that the orthoboric acid (H₃BO₃) is present suspended in a suspension medium, wherein the suspension medium containing orthoboric acid (H₃BO₃) is brought to a temperature at which water loss occurs via an energy source.

3. A process for the reversible thermochemical release of energy,
comprising a reaction system in which boric oxide (B₂O₃) or metaboric acid (HBO₂, H₂B₄O₇) or boric oxide (B₂O₃) and metaboric acid (HBO₂, H₂B₄O₇) are converted into orthoboric acid (H₃BO₃) by reaction with water,
characterized in that boric oxide (B₂O₃) or metaboric acid or boric oxide (B₂O₃) and metaboric acid (HBO₂, H₂B₄O₇) are present suspended in a suspension medium, wherein water is added to the suspension medium, wherein water is added to the suspension medium containing boric oxide (B₂O₃) or metaboric acid (HBO₂, H₂B₄O₇) or boric oxide (B₂O₃) and metaboric acid (HBO₂, H₂B₄O₇) so that the reaction to orthoboric acid (H₃BO₃) proceeds.

4. The process according to claim 1, characterized in that the metaboric acid is present as a powder which is suspended in the suspension medium.

5. The process according to claim 1, wherein additives, emulsifiers and/or foam inhibitors are additionally added to the suspension medium.

6. The process according to claim 1, wherein the suspension medium is refined rapeseed oil, mineral oil-based thermal oil or silicone-based thermal oil.

7. The process according to claim 1, wherein the suspension medium is stirred during the reaction.

8. The process according to claim 1, wherein, during thermochemical storage of energy, the water formed is removed from the suspension during the course of the reaction.

9. The process according to claim 8, wherein the water formed is removed by pumping and/or gassing, in particular with nitrogen.

10. The process according to claim 1, wherein the temperature during storage of energy is set to 110 to 200° C., preferably between 135-165° C.

11. The process according to claim 1, wherein the pressure during storage of energy is set to below 200 mbar, preferably below 100 mbar.

12. The process according to claim 1, wherein the pressure is set to at least 5 bar, preferably at least 8 bar, during the release of energy.

13. A system for the thermochemical storage of energy and release of energy, with at least one suspension reactor, wherein an energy source is associated with the suspension reactor, wherein an agitation device is provided in the suspension reactor, wherein an outlet for water vapor from the suspension reactor and a water reservoir connected to the outlet is present, wherein a feed line is provided into the suspension reactor which is connected to the water reservoir, wherein a heat exchanger is provided at the suspension reactor, wherein the heat exchanger is connectable to a consumer.

14. The system according to claim 13, wherein a control device is provided which is designed in such a way that the amount of energy delivered to the heat exchanger at the suspension reactor can be controlled.

15. The system according to claim 13, wherein a gas supply line is provided for the suspension reactor.

16. The system according to claim 15, wherein a heat exchanger is associated with the gas supply line.

17. The system according to claim 13, wherein a heat exchanger is assigned to the outlet.

18. The system according to claim 13, wherein the feed line has a device for controlling the flow rate.

19. The system according to claim 18, wherein the control device is designed in such a way that the amount of energy delivered to the heat exchanger at the suspension reactor can be controlled via the device for controlling the flow rate.

20. The system according to claim 13, wherein two suspension reactors are provided which are connected via at least one bypass line, wherein means for transporting the contents of one suspension reactor into the other suspension reactor are provided.

21. The system according to claim 13, wherein an energy source and a consumer are provided.

22. The system according to claim 13, wherein a device for preheating and/or evaporating the water is provided in the supply line.
